(19) United States
(12) Patent Application Publication
(10) Pub. No.: US 2016/0126627 A1
(43) Pub. Date: May 5, 2016

(54) METHOD AND APPARATUS FOR CONTROLLING ARRAY ANTENNA

(71) Applicant: ELECTRONICS AND TELECOMMUNICATIONS RESEARCH INSTITUTE, Daejeon (KR)

(72) Inventors: Yong Ho LEE, Daejeon (KR); Seung-Hwan LEE, Daejeon (KR)

(73) Assignee: ELECTRONICS AND TELECOMMUNICATIONS RESEARCH INSTITUTE, Daejeon (KR)

(21) Appl. No.: 14/850,574

(22) Filed: Sep. 10, 2015

(30) Foreign Application Priority Data
Oct. 29, 2014 (KR) 10-2014-0148690

(51) Int. Cl. H01Q 3/26; G05B 15/02

(52) U.S. Cl. CPC H01Q 3/2605; G05B 15/02

(57) ABSTRACT

A method and apparatus for controlling an array antenna through a step of generating control data by processing input data based on interrelationship between the n number of storage element included in generator, and a step of controlling a plurality of parasitic elements included in the array antenna based on the control data are provided.

### CROSS-REFERENCE TO RELATED APPLICATION

This application claims priority to and the benefit of Korean Patent Application No. 10-2014-0148690 filed in the Korean Intellectual Property Office on Oct. 29, 2014, the entire contents of which are incorporated herein by reference.

### BACKGROUND OF THE INVENTION

(a) Field of the Invention

The present invention relates to a method and apparatus for controlling an array antenna that can reform a radiation pattern.

(b) Description of the Related Art

Multiple input multiple output (MIMO) technology is technology that increases a capacity of a wireless communication channel by using a multiple antenna in a transmitting and receiving terminal. Theoretically, because a MIMO channel capacity increases in linear proportional to the number of transmitting and receiving antennas, the MIMO channel capacity is core technology of a next generation wireless transmission field that can remarkably increase use efficiency of a limited frequency resource. MIMO technology was adapted in various wireless communication standard specifications such as IEEE 802.11ac, WiMAX, and Long Term Evolution (LTE).

In order to increase a capacity of a radio channel, decorrelation should exist between MIMO channel paths. For decorrelation between MIMO channel paths, each element of a multiple antenna should be separated by a half wavelength or more of a signal. Because a spatial restriction of such a multiple antenna limits the number of antenna elements that may be disposed at a limited space, it is difficult to apply MIMO technology based on a plurality of antenna elements to a mobile communication apparatus. Further, in order to process a transmitting and receiving signal, because a radio frequency (RF) chain is required in each antenna element, power consumption increases, and it may be difficult to implement hardware. Therefore, research for implementing MIMO technology using a single RF chain-based array antenna has been performed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus having advantages of being capable of effectively controlling a parasitic element of an array antenna based on a single RF chain.

An exemplary embodiment of the present invention provides a method of controlling an array antenna. The method includes: generating control data by processing input data based on interrelationship between the n number of storage elements; and controlling a plurality of parasitic elements included in the array antenna based on the control data.

The generating of control data may include: performing feed-forward by inputting the input data to each of the n number of storage elements that are coupled in series; and generating the control data based on data that is output from n-th storage elements of the n number of storage elements.

The generating of control data may include: performing feedback by inputting data output from each of the n number of storage elements that are coupled in series to the input data; and generating the control data based on data that is output from n-th storage elements of the n number of storage elements.

Another embodiment of the present invention provides an apparatus that controls an array antenna. The apparatus includes: a controller configured to generate control data by processing input data based on interrelationship between n number of storage elements included in the controller; and a data transmitter configured to transmit the control data to the plurality of parasitic elements included in the array antenna.

The controller may perform feed-forward by inputting the input data to each of the n number of storage elements that are coupled in series, and generate the control data based on data that is output from n-th storage elements of the n number of storage elements.

The controller may perform feedback by inputting data output from each of the n number of storage elements that are coupled in series to the input data, and generate the control data based on data that is output from n-th of storage elements of the n number of storage elements.

### BRIEF DESCRIPTION OF THE DRAWINGS

FIG. 1 is a diagram illustrating an array antenna based on a single RF chain.

FIG. 2 is a diagram illustrating a load controller according to an exemplary embodiment of the present invention.

FIG. 3 is a diagram illustrating a plurality of storage elements according to an exemplary embodiment of the present invention.

FIG. 4 is a diagram illustrating a plurality of storage elements according to another exemplary embodiment of the present invention.

FIG. 5 is a diagram illustrating an array antenna according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In an entire specification, a mobile station (MS) may indicate a terminal, a mobile terminal (MT), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, a relay node (RN) that performs a BS function, an advanced relay station (ARS) that performs a BS function, a high reliability relay station (HR-RS) that performs a BS function, and a small-sized BS [a femto BS, a home node B(HNB), a home eNodeB(HeNB), a pico BS, a metro BS, and a micro BS], and may include an entire function or a partial function of the ABS, the nodeB, the eNodeB, the AP, the RAS, the BTS, the MMR-BS, the RS, the RN, the ARS, the HR-RS, and the small-sized BS.

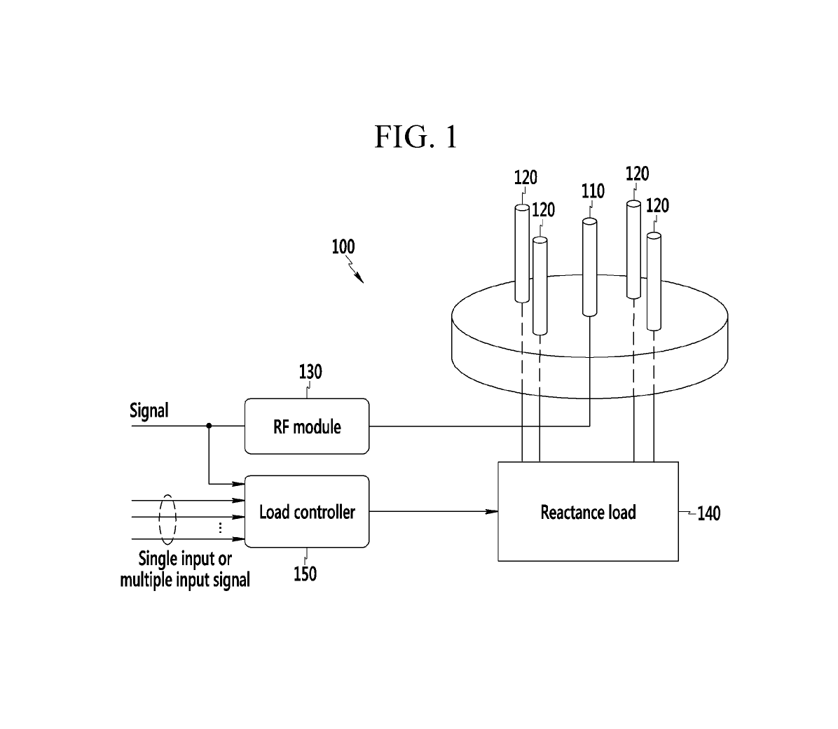

FIG. 1 is a diagram illustrating an array antenna based on a single RF chain.

Referring to FIG. 1, an array antenna 100 includes an active element 110, parasitic elements 120, an RF module 130, a reactance load 140, and a load controller 150.

The active element 110 is connected to the RF module 130. The RF module 130 transfers a signal to the active element 110.

A plurality of parasitic elements 120 are connected to the reactance load 140. In this case, the reactance load 140 may be connected on each parasitic element basis and is controlled by the load controller 150.

In general, by simultaneously radiating a plurality of patterns that are independently formed by a plurality of active elements, an antenna for MIMO technology transmits and receives a signal.

However, the array antenna 100 based on a single RF module 130 of FIG. 1 radiates one pattern that is formed by one active element 110 and a plurality of parasitic elements 120 that are located adjacent to the active element 110, thereby transmitting and receiving a signal. In this case, the active element 110 is controlled by the single RF module 130, and the parasitic element 120 may be controlled according to a value of the connected reactive load 140. The parasitic element 120 operates through mutual coupling to the active element 110.

Array antennas based on a single RF module 130 are various kinds, and in presently generally researched antennas, an electronically steerable parasitic array radiator (ESPAR) antenna exists. FIG. 1 represents a 5-element ESPAR antenna including four parasitic elements 120. When an array antenna that can reform a radiation pattern like a conventional ESPAR antenna controls the parasitic element 120, the array antenna uses data related to a corresponding time segment (or at present). For example, by applying an exclusive or (XOR) operation to data related to a corresponding time segment (or at present), the array antenna controlled the parasitic element 120.

In an exemplary embodiment of the present invention, by controlling the parasitic element 120 using data related to several time segments, a signal can be processed based on interrelationship between elements included in load controller.

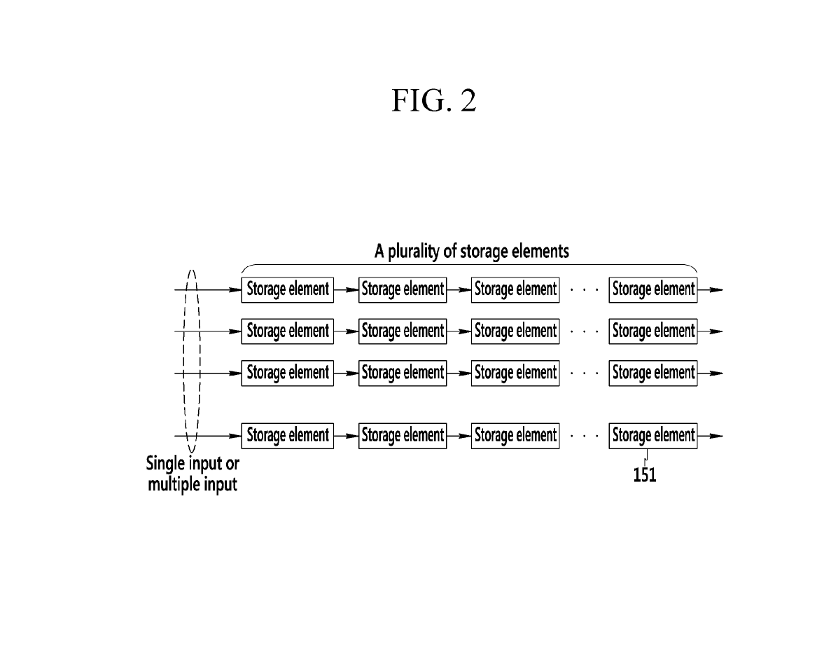

FIG. 2 is a diagram illustrating a load controller according to an exemplary embodiment of the present invention.

Referring to FIG. 2, a load controller according to an exemplary embodiment of the present invention includes at least one data receiver, a plurality of storage elements 151, and at least one data transmitter.

At least one data receiver may receive data for controlling the parasitic element 120.

The plurality of storage elements 151 may have interrelationship formed by a feed structure thereof. The plurality of storage elements 151 may be continuously coupled in series to each data receiver and each data transmitter. A method of processing input data based on the interrelationship between the plurality of storage elements 151 will be described in detail hereinafter.

At least one data transmitter may output data for controlling the parasitic element 120.

In an exemplary embodiment of the present invention, input data that is input to the data receiver of the load controller passes through the plurality of storage elements 151, and the load controller may process input data based on the interrelationship of the plurality of storage elements 151 and may output output data through the data transmitter.

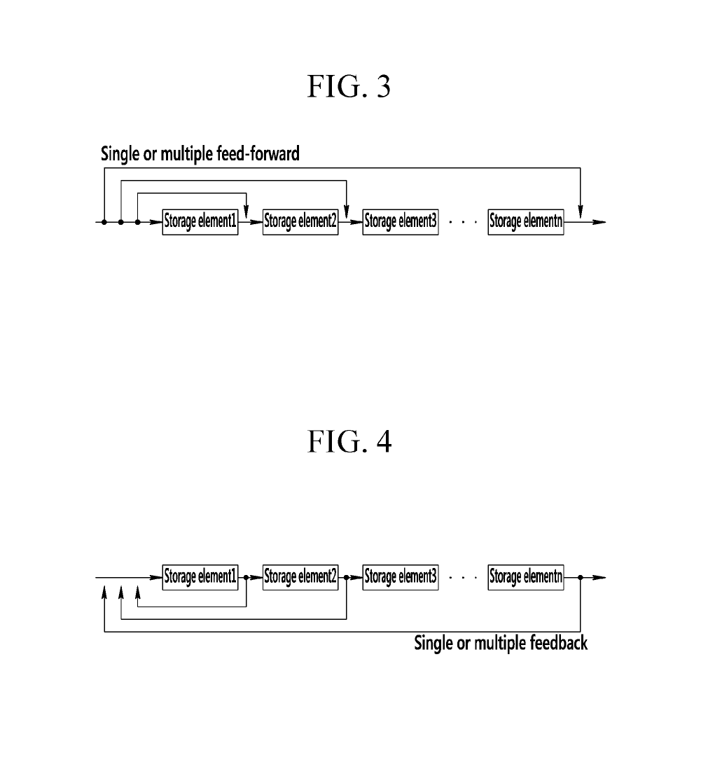

FIG. 3 is a diagram illustrating a plurality of storage elements according to an exemplary embodiment of the present invention.

Referring to FIG. 3, the n number of storage elements 151 are connected between a data receiver and a data transmitter.

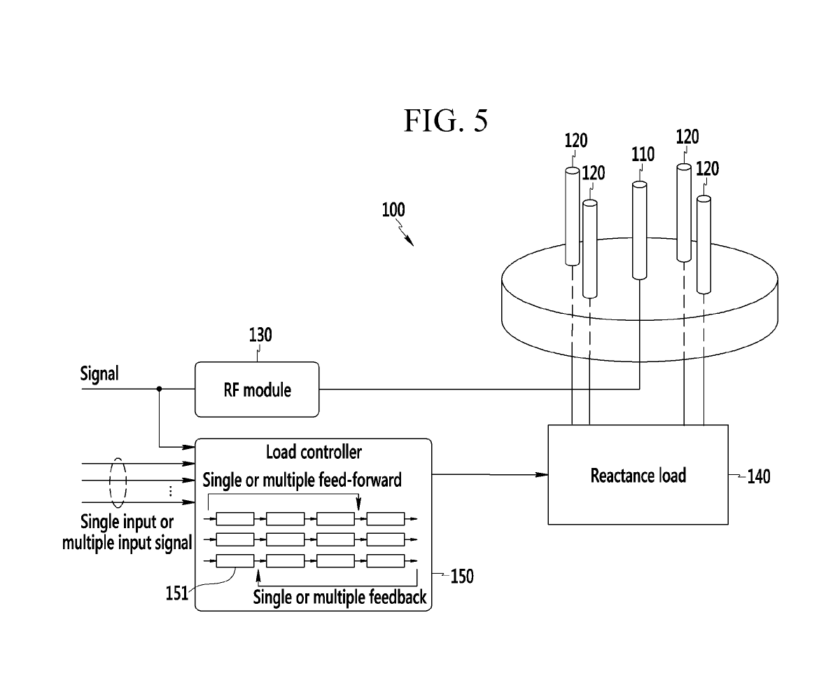

In an exemplary embodiment that is described with reference to FIG. 3, input data that is input to the data receiver may be each input to a first storage element, a second storage element, . . . , and an n-th storage element (feed-forward structure). In this case, at least one output data in respect of data that corresponds to n number of storage elements may be output from the n-th storage element based on the interrelationship between the pluralities of storage elements 151. FIG. 4 is a diagram illustrating a plurality of storage elements according to another exemplary embodiment of the present invention.

Referring to FIG. 4, the n number of storage elements 151 are connected between the data receiver and the data transmitter.

In an exemplary embodiment that is described with reference to FIG. 4, data that is output from the first storage element, data that is output from the second storage element, . . . , data that is output from the n-th storage element may each be fed back to the first storage element (feedback structure). In this case, at least one output data in respect of data that corresponds to n number of storage elements may be output from the n-th storage element based on the interrelationship between the pluralities of storage elements 151.

According to another exemplary embodiment of the present invention, the load controller may use one of the feed-forward structure of FIG. 3 and the feedback structure FIG. 4, and may simultaneously use the two structures. The present invention suggests a structure that can form interrelationship to output data based on the storage element 151 that is included in the load controller.

FIG. 5 is a diagram illustrating an array antenna according to an exemplary embodiment of the present invention.

A radiation pattern of a signal through an array antenna of FIG. 5 may be reformed. In this case, a load controller according to an exemplary embodiment of the present invention includes a plurality of storage elements 151.

As described above, a load controller according to an exemplary embodiment of the present invention may generate control data of each parasitic element 120 of an array antenna based on the interrelationship between the pluralities of storage elements 151. Further, as the load controller generates the control data of the parasitic element 120 based on the interrelationship, even in a data transmission symbol that is transferred to the active element 110 through an RF chain, a coding gain can be obtained. Further, the storage element 151 that is included in the load controller is coupled in series to an encoder or a decoder and can be decoded through a trellis-based MAP decoder. When an array antenna according to an exemplary embodiment of the present invention controls the parasitic element 120 based on the interrelationship of the load controller, in an antenna domain, a signal can be processed based on pattern correlation. The present invention may be implemented in a digital or analog terminal according to a design object of a user.

A load controller according to an exemplary embodiment of the present invention includes a processor and a memory. The memory is connected to the processor, and may store various information for driving the processor. The processor may implement the functions, processes, or methods proposed in accordance with an exemplary embodiment of the present invention. The operation of the load controller in accordance with an exemplary embodiment of the present invention may be implemented by the processor.

In accordance with an exemplary embodiment of the present invention, the memory may be placed inside or outside the processor, and may be connected to the processor through various known means. The memory may include a variety of types of volatile or non-volatile storage media, and may include read-only memory (ROM) or random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling an array antenna, the method comprising:
generating control data by processing input data based on interrelationship between the n number of storage elements; and
controlling a plurality of parasitic elements included in the array antenna based on the control data.

2. The method of claim 1, wherein the generating of control data comprises:
performing feed-forward by inputting the input data to each of the n number of storage elements that are coupled in series; and
generating the control data based on data that is output from n-th storage elements of the n number of storage elements.

3. The method of claim 1, wherein the generating of control data comprises:
performing feedback by inputting data output from each of the n number of storage elements that are coupled in series to the input data; and
generating the control data based on data that is output from n-th storage elements of the n number of storage elements.

4. An apparatus that controls an array antenna, the apparatus comprising:
a controller configured to generate control data by processing input data based on interrelationship between n number of storage elements included in the controller; and
a data transmitter configured to transmit the control data to the plurality of parasitic elements included in the array antenna.

5. The apparatus of claim 4, wherein the controller performs feed-forward by inputting the input data to each of the n number of storage elements that are coupled in series, and generates the control data based on data that is output from n-th storage elements of the n number of storage elements.

6. The apparatus of claim 4, wherein the controller performs feedback by inputting data output from each of the n number of storage elements that are coupled in series to the input data, and generates the control data based on data that is output from n-th of storage elements of the n number of storage elements.
